(19) United States
(12) Patent Application Publication
(10) Pub. No.: US 2026/0196785 A1
(43) Pub. Date: Jul. 9, 2026

(54) ETHERNET CONNECTOR FOR A MOTOR VEHICLE

(71) Applicant: ZF CV Systems Global GmbH, Bern (CH)

(72) Inventor: Ariel Kotulski, Wroclaw (PL)

(21) Appl. No.: 19/442,154

(22) Filed: Jan. 7, 2026

(30) Foreign Application Priority Data
Jan. 9, 2025 (EP) 25150806.5

(51) Int. Cl. H01R 24/64

(52) U.S. Cl. CPC H01R 24/64; H01R 2201/26

(57) ABSTRACT

An ethernet connector (4) for a motor vehicle (2) has two signal leads (5 – 8) arranged adjacent each other, each having a rectangular cross section with a width (w) and a height (h), the height (h) being smaller than the width (w). A height side of each signal lead defines the height and a width side defines the width. In a first portion (L1) of the connector (4), the at least two signal leads (5 – 8) are each arranged with the width sides being parallel to each other and to a longitudinal axis (L) of the signal leads. In a second portion (L2) of the connector (4), at least a first one of the signal leads (5 – 8) is twisted by 90° with respect to the first portion (L1) around the longitudinal axis (L) of the first one of the signal leads.

### FIELD

The disclosure is directed to an ethernet connector for a motor vehicle, an electrical system for a motor vehicle comprising the ethernet connector, a motor vehicle comprising the electrical system, and a method for manufacturing the ethernet connector.

### BACKGROUND

An on-board electrical system can refer to electrical components in vehicles such as cars and commercial vehicle, e.g. trucks.

The electrical components of an on-board electrical system can include wiring and on-board voltage sockets, control units, sensors, display elements (e.g. warning and indicator lights, displays etc.), actuators (e.g. electric motors, lights and lighting systems etc.), bus systems, energy storage devices (e.g. batteries or accumulators etc.), generators, driver assistance systems, and/or comfort settings (e.g. electric seat adjustment etc.)

The on-board electrical system can be responsible for the power supply (energy on-board electrical system) and/or the flow of information between those components (communication on-board electrical system).

The electrical system may make use of Ethernet. Ethernet is a family of wired computer networking technologies. It was commercially introduced in 1980 and first standardized in 1983 as IEEE 802.3. Ethernet has since been refined to support higher bit rates, a greater number of nodes, and longer link distances, but retains much backward compatibility.

Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. Per the OSI model, Ethernet provides services up to and including the data link layer.

The on-board electrical system may comprise an ethernet connector. An ethernet connector is for example described in EP 3171461 A1.

The connector may comprise two or more signal leads. A signal lead may be defined as a pathway through which (ethernet) data signals travel or transmitted using copper or other conductors. The signal leads have to be spaced apart from each other by a certain minimum distance in order to work correctly, i.e. such that the ethernet signals are transmitted effectively, ensuring they remain free from interference and do not disrupt one another. This minimum distance can be hard to achieve with certain envelopes, i.e. mechanical boundaries that function as a clearly defined perimeter or limit and cannot be crossed due to manufacturability or safety.

### SUMMARY

Against the background of this state of the art, one object of the present disclosure is to specify a device and/or a method, each of which is suitable for enriching the state of the art.

The object is solved by the features of the present disclosure and optional further developments of the disclosure.

An ethernet connector for a motor vehicle is provided. The connector comprises at least two signal leads arranged adjacent each other. The signal leads each have a rectangular cross section with a width and a height, the height being smaller than the width. In a first portion of the connector, the at least two signal leads are arranged such that a width side of a first one of the at least two signals leads and a width of a second one of the at least two signal leads extend parallel to a longitudinal axis of the respective signals leads. In a second portion of the connector, at least the first one of the at least two signal leads is twisted by 90° with respect to the first portion around the longitudinal axis of the first one of the at least two signal leads such that a height side of the first one of the at least two signals leads in the second portion extends parallel to the width side in the first portion.

In other words, the Ethernet lead shape may be changed by twisting the ethernet lead about an 90° angle around or with respect to its longitudinal axis. This accommodates a lack of space, i.e. to arrange the signal leads closer to each other while keeping the same distance between the leads and while keeping the same cross section of the leads.

The Ethernet standard that may be used by the connector is for example IEEE 802.3bw 100BASE-T1 (100 Mbps) and IEEE802.3bp 1000BASE-T1 (1 Gbps) (version as of the date of filing of this application).

The longitudinal direction can be the direction being perpendicular to the cross section. The height of the cross section can be measured along the height direction thereof. The width of the cross section may be measured along the width thereof. The height direction and the width direction may enclose an angle of 90°. A height side of the signal lead defines the height and a width side defines the width.

The motor vehicle can be a passenger car, optionally an automobile, or a commercial vehicle, such as a bus, tractor and/or truck. The truck may comprise a tractor unit and/or one or more trailers.

Furthermore, the definitions and explanations provided above apply mutatis mutandis to the proposed ethernet connector.

In the following, optional further developments of the above described ethernet connector are explained in detail.

In one aspect, in the second portion of the connector, only the first one of the at least two signal leads is twisted by 90° with respect to the first portion around the longitudinal axis of the first one of the at least two signal leads, such that the height direction of the first one of the at least two signals leads is perpendicular to the height direction of the second one of the at least two signal leads. The height side in the second portion is parallel to the width side in the first portion.

In another aspect, in the second portion of the connector, the first one of the at least two signal leads is twisted by 90° with respect to the first portion around the longitudinal axis of the first one of the at least two signal leads. And, in the second portion of the connector, the second one of the at least two signal leads is twisted by 90° with respect to the first portion along a longitudinal axis of the second one of the at least two signal leads. Therefore, the width direction of the first one of the at least two signals leads extend parallel to a width direction of the second one of the at least two signal leads. The height sides in the second portion are parallel to each other and to the longitudinal axis, and are parallel to the width sides of the first portion.

In other words, one or more, e.g. two, of the signal leads may be twisted by 90°, respectively, in order to achieve the above described effect of at least keeping a required minimum distance between the leads while reducing an overall space needed for the leads inside the connector.

In a third portion of the connector, at least the first one of the at least two signal leads can be twisted by 90° with respect to the second portion around the longitudinal axis of the first one of the at least two signal leads, such that the height direction of the first one of the at least two signals leads extends parallel to the longitudinal axis of the first one of the at least two signal leads. The width side in this portion is parallel to the height side in the second portion and the width side in the first portion.

In other words, optionally, when there is more space available in the connector, the one or more of the twisted leads may be twisted back and may be arranged in the same way as in the first portion.

In one aspect, along the longitudinal axis of the first one of the at least two signal leads, the first portion of the connector is followed by the second portion of the connector, which is in turn followed by the third portion of the connector. Along the longitudinal axis of the second one of the at least two signal leads, the first portion of the connector is followed by the second portion of the connector, which is in turn followed by the third portion of the connector.

In the second portion of the connector, the at least two signal leads may be spaced apart from each other by a distance of at least 0.9 mm, optionally at least 1.3 mm.

Those distances are suitable to ensure that the signal leads work correctly.

In one aspect, the connector has an overmold that fixes a position of the at least two signal leads with respect to each other.

That is, the overmold may hold the signal leads in place. The overmold may be manufactured using overmolding which is a specialized injection molding process where one material is molded over another. The overmold is molded in a first stage and is put in a second and separate stage of the manufacturing process into a bigger form to be molded again

An electrical system or a wiring system for a motor vehicle is also provided according to aspect of the disclosure, the system including the ethernet connector described above.

A motor vehicle is also provided according to an aspect of the disclosure, the motor vehicle including the system described above.

In another aspect, a method for manufacturing an ethernet connector for a motor vehicle is provided. The method comprises arranging at least two signal leads adjacent each other. The signal leads each have a rectangular cross section with a width and a height, the height being smaller than the width. In a first portion of the connector, the at least two signal leads are arranged such that a height direction of a first one of the at least two signals leads and a height direction of a second one of the at least two signal leads extend parallel to a longitudinal axis of the respective signals leads. The height sides defines the height and the width sides define the width. In a second portion of the connector, at least the first one of the at least two signal leads is twisted by 90° with respect to the first portion around the longitudinal axis of the first one of the at least two signal leads such that the height side in the second portion is parallel to the width side in the first portion.

The description given above with respect to the ethernet connector applies mutatis mutandis to the method and vice versa.

### BRIEF DESCRIPTION OF THE DRAWINGS

Exemplary embodiments of the present disclosure are described in further detail below with reference to the Figures, in which:

FIG. 1 schematically shows a connector frame comprising an ethernet connector that forms part of an electrical system of a motor vehicle in a top view,

FIG. 2 schematically shows the ethernet connector of FIG. 1 in a top view, and

FIG. 3 shows two signal leads of the ethernet connector shown in FIGS. 1 and 2.

### DETAILED DESCRIPTION

Common reference signs relate to the similar parts throughout the description of the Figures.

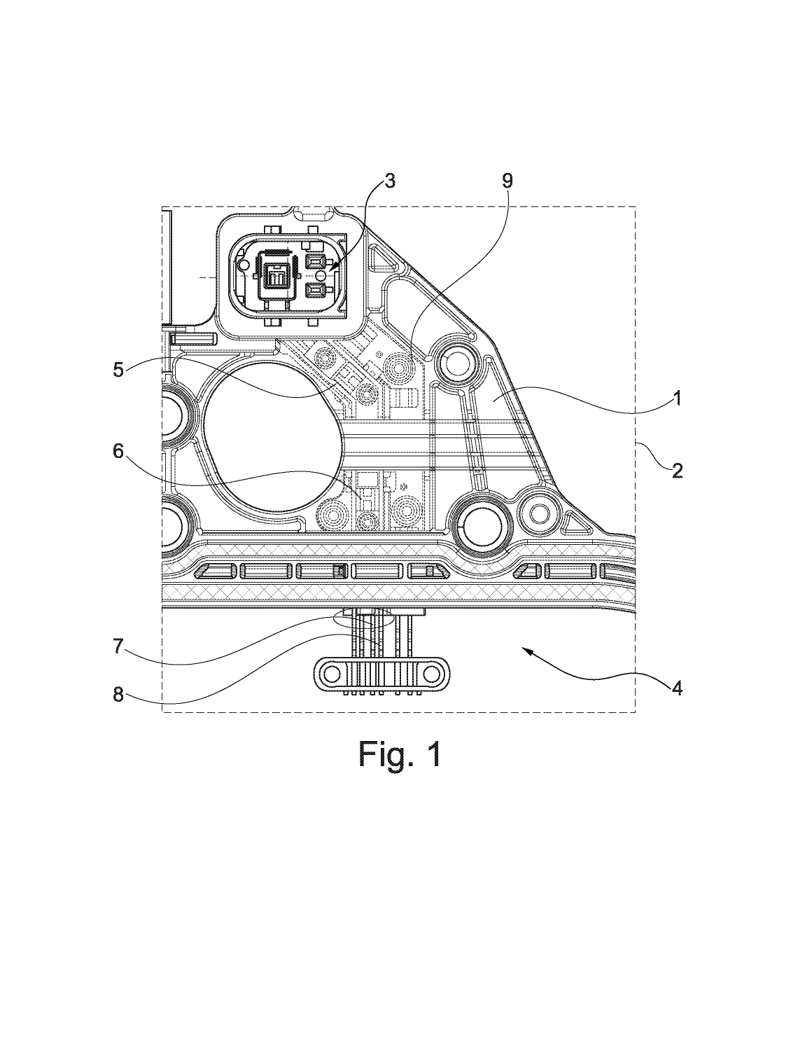

In FIG. 1 a connector frame 1 is shown. The frame 1 forms part of a motor vehicle 2 (not shown in more detail). The frame 1 comprises an ethernet connector 4 with an interface 3 which in turn forms part of a wiring system (not shown in more detail) of the motor vehicle 2. The interface 3 may be a female or male part. Here, the interface 3 is a female part configured to receive a male part (not shown) of another ethernet connector. The shown ethernet connector 4 may form part of gearbox control unit that may be connected via the interface 3 to the gear box (not shown) of the vehicle 2.

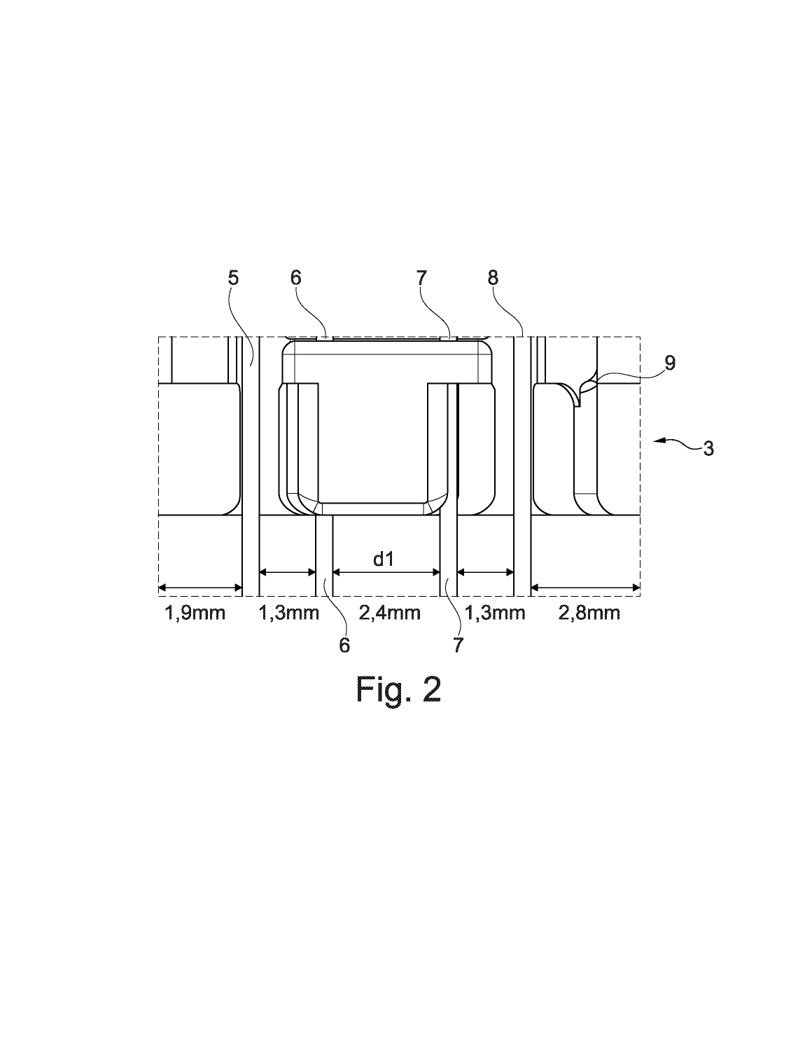

As can also be gathered from FIG. 2, showing the circled portion of FIG. 1 in more detail, the ethernet connector 4 comprises four signal leads 5 – 8, the four signal leads 5 – 8 being arranged adjacent each other. The ethernet connector 4 comprises an overmold 9 that holds the four signal leads 5 – 8 and fixes a position of the four signal leads 5 – 8 with respect to each other.

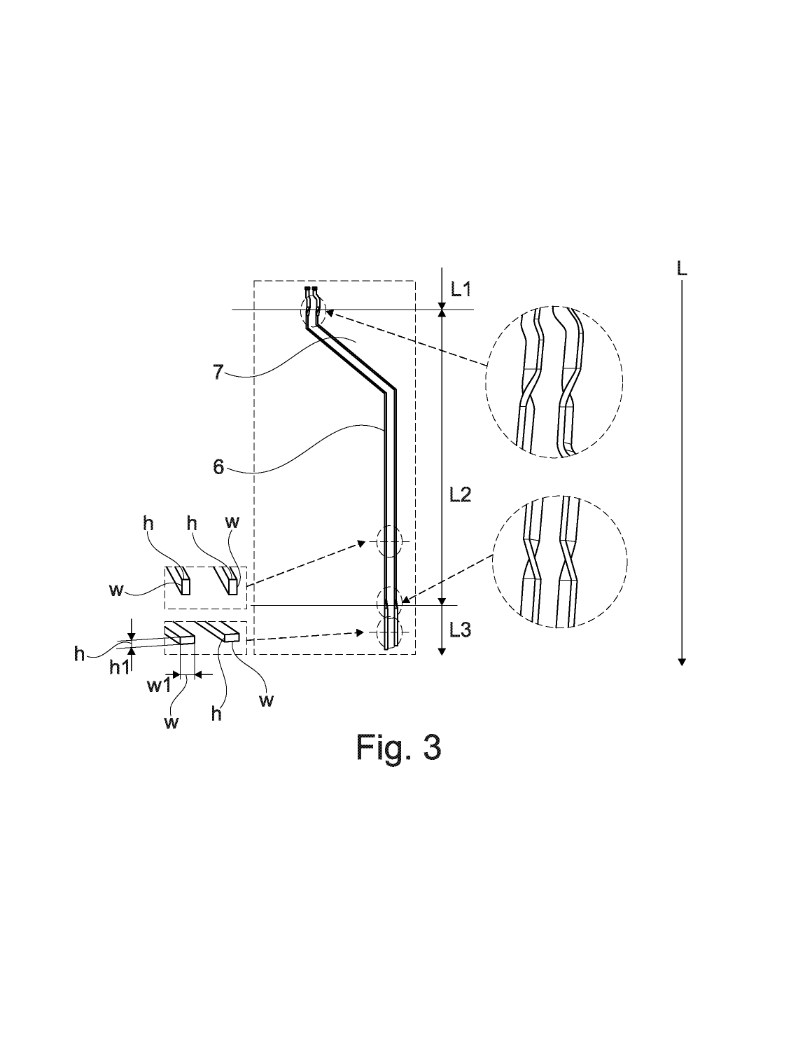

As can be gathered from FIG. 3, showing the two inner ones 6, 7 of the four signals leads 5 – 8 in detail, at least said two signal leads 6, 7 each have a rectangular cross section with a width w and a height h, the height h being smaller than the width w.

With reference to FIG. 3, the connector 4 and also the two signal leads may be divided into three portions L1 – L3. Along a longitudinal axis L of the two signal leads 6, 7, a first portion L1 of the connector 4 is followed by a second portion L2 of the connector 4, which is in turn followed by a third portion L3 of the connector 4.

In the first portion L1 of the connector 4, the at least two signal leads 6, 7 are arranged such that respective height directions h1 of the two signals leads 6, 7 extend parallel to each other along the respective longitudinal axis L of the two signal leads 6, 7. A height side of each signal lead defines the height and a width side defines the width.

At the beginning of the second portion L2, both signal leads 6, 7 are twisted by 90° with respect to the first portion L1 around their respective longitudinal axis L such that the width directions w1 of the two signals leads 6, 7 extend in the second portion L2 parallel to each other along the respective longitudinal axis L of the two signal leads 6, 7. In the second portion L2, the at least two signal leads are spaced apart from each other by a distance d1 of at least 0.9 mm, optionally at least 1.3 mm, here 2.4 mm (see FIG. 2). In the second portion, the height sides are parallel to each other and to the longitudinal axis. The height sides in the second portion are parallel to width sides in the first portion due to the twisting. The signal leads are bent in the second portion, such that the width sides define transverse planes and the height sides remain in the same plane.

It should be noted, that it is also possible that only one of the two signal leads 6, 7 is twisted in the second portion L2.

At the beginning of the third portion L3, both signal leads 6, 7 are twisted by 90° with respect to the second portion L2 around their respective longitudinal axis L such that the respective height directions h1 of the two signals leads 6, 7 extend parallel to each other along the respective longitudinal axis L of the two signal leads 6, 7. The width sides in the third portion are parallel to each other and the longitudinal axis. The width sides in the third portion are parallel to the height sides in the second portion and the width sides in the first portion.

### Reference Signs (Part of the Description)

1 connector frame

2 motor vehicle

3 ethernet connector interface

4 ethernet connector

5 - 8 signal lead

9 overmold

d1 distance

h height

h1 height direction

L longitudinal axis

L1 first portion

L2 second portion

L3 third portion

w width

w1 width direction

What is claimed is:

1. An ethernet connector (4) for a motor vehicle (2), comprising:
at least two signal leads (5 – 8) arranged adjacent to each other,
wherein the signal leads (5 – 8) each have a rectangular cross section with a width (w) and a height (h), wherein the height (h) is smaller than the width (w),
wherein each of the signal leads have a height side that defines the height (h) and a width side that defines the width (w);
a first portion (L1) of the connector (4), in which the width side of a first one of the at least two signal leads (5 – 8) and the width side of a second one the at least two signal leads (5 – 8) run parallel to each other along a longitudinal axis (L) of the respective signal leads (5 – 8), and
a second portion (L2) of the connector (4), in which at least the first one of the at least two signal leads (5 – 8) is twisted by 90° with respect to the first portion (L1) around the longitudinal axis (L) of the first one of the at least two signal leads (5 – 8), such that the height side of the first one of the at least two signal leads in the second section (L2) is parallel to the width side of the first one of the at least two signal leads in the first portion (L1).

2. The ethernet connector (4) according to claim 1,
wherein, in the second portion (L2) of the connector (4), only the first one of the at least two signal leads (5 – 8) is twisted by 90° with respect to the first portion (L1) around the longitudinal axis (L) of the first one of the at least two signal leads (5 – 8),
wherein, in the second portion (L2) of the connector (4), the height side of the first one of the at least two signals leads (5 – 8) is perpendicular to the width side of the second one of the at least two signal leads (5 – 8).

3. The ethernet connector (4) according to claim 1,
wherein in the second portion (L2) of the connector (4), the first one of the at least two signal leads (5 – 8) is twisted by 90° with respect to the first portion (L1) around the longitudinal axis (L) of the first one of the at least two signal leads (5 – 8), and
wherein in the second portion (L2) of the connector (4), the second one of the at least two signal leads (5 – 8) is twisted by 90° with respect to the first portion (L1) along a longitudinal axis (L) of the second one of the at least two signal leads (5 -8) such that the height side of the second one of the at least two signal leads in the second section (L2) is parallel to the width side of the second one of the at least two signal leads in the first section (L1)
wherein the height side of the first one of the at least two signals leads (5 – 8) runs parallel to the height side of the second one of the at least two signal leads (5 – 8).

4. The ethernet connector (4) according to claim 1,
wherein in a third portion (L3) of the connector (4), at least the first one of the at least two signal leads (5 – 8) is twisted by 90° with respect to the second portion (L2) around the longitudinal axis (L) of the first one of the at least two signal leads (5 – 8), wherein the width side of the first one of the at least two signals leads (5 – 8) in the third portion (L3) is parallel to height side of the first one of the at least two signal leads (5 – 8) in the second portion (L2).

5. The ethernet connector (4) according to claim 4,
wherein along the longitudinal axis (L) of the first one of the at least two signal leads (5 - 8), the first portion (L1) of the connector (4) is followed by the second portion (L2) of the connector (4), which is in turn followed by the third portion (L3) of the connector (4), and
wherein along the longitudinal axis (L) of the second one of the at least two signal leads (5 – 8), the first portion (L1) of the connector (4) is followed by the second portion (L2) of the connector (4), which is in turn followed by the third portion (L3) of the connector (4).

6. The ethernet connector (4) according to claim 1, wherein in the second portion (L2) of the connector (4), the at least two signal leads (5 – 8) are spaced apart from each other by a distance (d1) of at least 0.9 mm, optionally at least 1.3 mm.

7. The ethernet connector (4) according to claim 1, wherein the connector (4) comprises an overmold (9) that fixes a position of the at least two signal leads (5 – 8) with respect to each other.

8. A wiring system for a motor vehicle (2), the system comprising the ethernet connector (4) according to claim 1.

9. A motor vehicle (2), the motor vehicle (2) comprising the wiring system according to claim 8.

10. A method for manufacturing an ethernet connector (4) for a motor vehicle (2), comprising:
arranging at least two signal leads (5 – 8) adjacent to each other,
wherein the signal leads (5 – 8) each have a rectangular cross section with a width (w) and a height (h), the height (h) being smaller than the width (w),
wherein each of the signal leads have a height side that defines the height (h) and a width side that defines the width (w);
arranging a first portion (L1) of the connector (4) such that the at least two signal leads (5 – 8) are arranged with the width side of a first one of the at least two signals leads (5 – 8) and the width side of a second one of the at least two signal leads (5 – 8) being parallel to each other and a longitudinal axis (L) of the respective signal leads (5 – 8), and
arranging a second portion (L2) of the connector (4), in which at least a first one of the at least two signal leads (5 – 8) is twisted by 90° with respect to the first portion (L1) around the longitudinal axis (L) of the first one of the at least two signal leads (5 – 8) such that the height side of the first one of the at least two signals leads (5 – 8) in the second portion (L2) runs parallel to the width side of the first one of the at least two signal leads (5 – 8) in the first portion (L1).

11. The method according to claim 10,
wherein, in the second portion (L2) of the connector (4), only the first one of the at least two signal leads (5 – 8) is twisted by 90° with respect to the first portion (L1) around the longitudinal axis (L) of the first one of the at least two signal leads (5 – 8),
wherein, in the second portion (L2) of the connector (4), the height side of the first one of the at least two signals leads (5 – 8) is perpendicular to the width side of the second one of the at least two signal leads (5 – 8).

12. The method according to claim 10,
wherein in the second portion (L2) of the connector (4), the first one of the at least two signal leads (5 – 8) is twisted by 90° with respect to the first portion (L1) around the longitudinal axis (L) of the first one of the at least two signal leads (5 – 8), and
wherein in the second portion (L2) of the connector (4), the second one of the at least two signal leads (5 – 8) is twisted by 90° with respect to the first portion (L1) along a longitudinal axis (L) of the second one of the at least two signal leads (5 - 8) such that the height side of the second one of the at least two signal leads in the second section (L2) is parallel to the width side of the second one of the at least two signal leads in the first section (L1)
wherein the height side of the first one of the at least two signals leads (5 – 8) runs parallel to the height side of the second one of the at least two signal leads (5 – 8).

13. The method according to claim 10,
wherein in a third portion (L3) of the connector (4), at least the first one of the at least two signal leads (5 – 8) is twisted by 90° with respect to the second portion (L2) around the longitudinal axis (L) of the first one of the at least two signal leads (5 – 8), wherein the width side of the first one of the at least two signals leads (5 – 8) in the third portion (L3) is parallel to height side of the first one of the at least two signal leads (5 – 8) in the second portion (L2).

14. The method according to claim 13,
wherein along the longitudinal axis (L) of the first one of the at least two signal leads (5 - 8), the first portion (L1) of the connector (4) is followed by the second portion (L2) of the connector (4), which is in turn followed by the third portion (L3) of the connector (4), and
wherein along the longitudinal axis (L) of the second one of the at least two signal leads (5 – 8), the first portion (L1) of the connector (4) is followed by the second portion (L2) of the connector (4), which is in turn followed by the third portion (L3) of the connector (4).

15. The method according to claim 10, wherein the method includes bending at least the first one of the at least two signal leads about an axis transverse to the longitudinal axis (L) of the first one of the at least two signal leads, such that the height side along the longitudinal axis (L) in the second portion (L2) remains parallel to the width side in the first portion (L1) and the width side in the second portion (L2) is bent and defines a plurality of transverse surfaces.

16. The ethernet connector (4) according to claim 1,
wherein, in the first portion (L1), the at least two signal leads are spaced apart laterally such that the height sides occupy a common height dimension, wherein the at least two signal leads define a first common thickness defined by a height measurement of the height sides;
wherein, in the second portion (L2), the at least two signal leads are spaced apart laterally such that the width sides occupy a common width dimension and the width sides are spaced apart laterally, wherein the at least two signal leads define a second common thickness defined by a width measurement of the height sides;
wherein the second common thickness is greater than the first common thickness such that the at least two signal leads have a reduced thickness in the first portion (L1) relative to the second portion (L2).

17. The ethernet connector (4) according to claim 1, wherein the at least two signal leads bend in the second portion (L2) and occupy a common plane through both the first portion (L1) and the second portion (L2).

18. The ethernet connection (4) according to claim 1, wherein the second portion (L2) transitions to a third portion (L3), wherein the first portion (L1) and the third portion (L3) define opposite terminal ends of the at least two signal leads, wherein the opposite terminal ends of the at least two signal leads are offset laterally relative to each other.

19. The ethernet connection (4) according to claim 1, wherein a total lateral space occupied by the at least two signal leads is reduced in the second portion (L2) relative to the first portion (L1).
